(19) United States
(12) Patent Application Publication
(10) Pub. No.: US 2010/0140238 A1
(43) Pub. Date: Jun. 10, 2010

(54) MACHINING SCORE LINES IN A RUPTURE DISC USING LASER MACHINING

(75) Inventors: Robert M. Mozley, Raytown, MO (US); Gabriel Hernandez, Kansas City, MO (US)

Correspondence Address: HUSCH BLACKWELL SANDERS LLP, 190 Carondelet Plaza, Suite 600, ST. LOUIS, MO, 63105, US

(73) Assignee: CONTINENTAL DISC CORPORATION, Liberty, MO (US)

(21) Appl. No.: 12/403,828

(22) Filed: Mar. 13, 2009

Related U.S. Application Data
(63) Continuation-in-part of application No. 12/331,611, filed on Dec. 10, 2008.

(51) Int. Cl. B23K 26/00

(52) U.S. Cl. 219/121.72

(57) ABSTRACT

A method of forming a score line in a rupture disc using a laser is provided, wherein the method includes selecting a wavelength for the laser that maximizes absorption of the laser radiation by the disc material, selecting a pulse duration for the laser that maximizes a peak power of the laser, selecting a pulse repetition rate for the laser that reduces a heat affected zone of the rupture disc during ablation, and selecting the speed of relative motion between the laser and the rupture disc. The score line is ablated in the rupture disc using the laser to remove material from the rupture disc as vapor without melting or oxidizing disc material adjacent the material being removed.

### CROSS-REFERENCE TO RELATED APPLICATION

This application is a continuation-in-part application of U.S. patent application Ser. No. 12/331,611, filed Dec. 10, 2008, the entire contents of which are hereby incorporated by reference in their entirety.

### BACKGROUND OF THE INVENTION

The present invention relates generally to a method of machining lines of weakness in a rupture disc and, more particularly, to a method of machining score lines in a rupture disc using laser technology.

Systems and vessels that contain a pressurized fluid often include rupture discs that relieve the system in the event of over pressurization. Rupture discs may take on a variety of shapes and configurations depending upon the specific application such as a dome shaped disc or a substantially flat shaped disc and such discs are generally placed in a vent or pressure vessel to prevent flow of the fluid through the vent until the disc ruptures. Specifically, as a system becomes over-pressurized and reaches a predetermined pressure, the disc ruptures to allow flow of the fluid through the venting system thereby relieving the pressure within the system.

Rupture discs are commonly formed as a forward acting tension type disc or a reverse-acting rupture disc. Forward acting tension type discs could be dome shaped or flat and may include a score line in the surface of the disc to ensure that the disc opens at a predetermined pressure and pattern of opening. Reverse-acting rupture discs may likewise be formed in a dome shape with a rated reversal load or pressure under which the pressure of the system causes the disc dome to buckle or collapse and rupture. Accordingly, both types of rupture discs require a selective adjustment of the rated reversal load or pressure to satisfy individual rupture values specified by customers. Other forms of specific types of rupture discs may also include substantially flat panels or flat rupture diaphragms used for deflagration venting. These panels or diaphragms may also include score lines to control the opening pattern and to ensure that the panel opens at a predetermined pressure. Accordingly, such panels also require a selective adjustment of the rated pressure to satisfy individual rupture values specified by customers. Rupture diaphragms for a specific type of venting are sometimes called vent panels, explosion vents, rupture panels or explosion panels and they can be designed in round, square, rectangular, or other shapes to effectively provide a vent relief area to fit the available mounting space.

It is standard practice by manufacturers to form lines of weakness (score lines) of various configurations, typically circumferential scores or cross scores, on a surface of the rupture disc to control the opening of the disc at a required burst pressure. These score lines are formed with various depths, widths, and lengths to further control the opening of the disc. To date, the only commercially successful means of forming the score lines includes using mechanical score dies and laser-defined electropolishing.

Typically, forming score lines using metal score dies causes changes in the grain structure and density of the metal in the area surrounding the score line thereby creating residual stresses in the disc. The residual stresses negatively affect the capacity of the disc to withstand multiple cyclic loads thereby reducing the service life of the disc. Moreover, metal scoring is difficult to control with high precision resulting in a significant increase in setup time and other non-value added costs during production.

U.S. Patent Application Publication No. 2006/0237457 describes a process that includes using a laser beam to define a path for a score line on a coating of resist material disposed on the surface of the disc. More specifically, a layer of resist material is provided on at least one face of the disc by dipping the disc in a solution of the resist material. A lacquer formulation is the preferred resist material. After hardening of the resist material, a laser beam is used to remove a portion of the resist material from the face of the disc, most usually along a C-shaped line adjacent to but spaced inboard of the transition region between the bulged section and the peripheral flat plane section of the disc. The laser beam is controlled such that the beam removes almost all of the resist material, while leaving only a minute residuum of the resist material on the surface of the disc. The laser beam is controlled so as not to fully penetrate the resist material and so as not to directly contact and therefore oxidize the surface of the metal of the disc along the path of travel of the beam. The laser disc is then positioned in electro polishing equipment containing an acid agent bath and an electro polishing operation is used to remove metal from the previously laser defined path until the required depth of the recess is formed by electro polishing. Thereafter, the resist material is removed and the disc is subjected to cleaning. Unfortunately, this process requires multiple successive operations and is therefore more expensive and time consuming than applying a laser beam directly to the disc material to create the score lines.

Chemical etching provides another means for forming a score line. However, as described in U.S. Patent Application Publication No. 2006/0237457 at paragraphs [0012-0016], this process can roughen the exposed surface of the disc and increase stress on the score line during cycling thereby reducing the disc's service life. Further, the roughened score line is more susceptible to corrosive effects thereby further decreasing the service life of the disc. Still further, chemical etching also involves the cumbersome handling of hazardous materials. In addition, the costs of etching make this process impractical for commercial application.

The use of laser machining to directly score the disc has been dismissed in the past. Laser machining is a material removal process achieved through an interaction between a laser and a target material. The laser machining process transports photon energy into the target material in the form of thermal or photochemical energy. The energy removes material by melting the material or through direct vaporization or ablation. The results of laser machining typically depend on several laser properties, for example: power, wavelength, focal spot size, and transverse and temporal modes. Moreover, to be used in material machining, lasers must have sufficient power. Accordingly, there are few practical types of lasers available for material machining. Such lasers include solid-state lasers, for example yttrium aluminum garnet (YAG) lasers, and gas lasers, for example CO₂ lasers or excimer lasers.

U.S. Patent Application Publication No. 2006/0237457 teaches in paragraph [0011] that the proposal of using a laser beam directly on a disc for forming score lines has “not proved commercially satisfactory for a number of reasons.” Specifically, “the reflectivity of the metal makes it difficult to control the penetration of the laser into the thickness of the metal”. Accordingly, the ability to form a smooth groove of uniform depth in the surface of the disc is decreased. “Furthermore, lasers significantly heat and burn the disc, oxidize the material and change the metallurgy of the metal. Discs having score lines burned by a laser have been found to be unsatisfactory in use, not only from the standpoint of unreliable openings at required pressure relief values, but also having undesirable cycle life”.

Accordingly, because the capabilities and advantages of laser machining outweigh its limitations, there is a need to control the limitations of laser machining by controlling certain laser properties to achieve acceptable laser beam interaction with the material to produce acceptable machining of score lines in rupture discs.

### SUMMARY OF THE INVENTION

The present invention provides a method for forming a score line on a rupture disc by directly removing material from the disc using a laser.

In one embodiment, a method of forming a score line in a rupture disc using a laser is provided wherein the method includes determining the score line requirements for the rupture disc and selecting a laser system having certain parameters capable of achieving the score line requirements. These laser system parameters include selecting a wavelength for the laser that maximizes absorption of the laser radiation by the disc material, selecting a pulse duration for the laser that maximizes a peak power of the laser, selecting a pulse repetition rate for the laser that reduces a heat affected zone of the rupture disc during ablation, and selecting the speed of the relative motion between the laser beam and the disc. The score line is ablated in the rupture disc using the laser to remove material from the rupture disc as vapor without melting or oxidizing disc material adjacent the material being removed.

In another embodiment, a method of forming a score line in a rupture disc using a laser is provided wherein the method includes determining score line requirements for the rupture disc and adjusting parameters of the laser to achieve the score line requirements. The parameters are adjusted by adjusting at least one of an optical output power of the laser, a pulse repetition rate of the laser to enable residual heat to be retained in a scoring zone of the rupture disc, a focal spot diameter of the laser beam, and the speed of the relative motion between the laser beam and the disc to enable achieving the score line requirements for the rupture disc. The score line is ablated in the rupture disc using the laser to remove material from the rupture disc as vapor without melting or oxidizing disc material adjacent the material being removed.

In a further embodiment, a method of forming a score line in a rupture disc using a laser is provided. The method includes determining score line requirements for the rupture disc and selecting a laser system having a wavelength that enables absorption of the laser energy by the disc material, a pulse duration that maximizes a peak power of the laser, a pulse repetition rate that reduces a heat affected zone of the rupture disc during ablation, a focal spot diameter, and the speed of the relative motion between the laser beam and the disc that achieves the precision and tolerances of the score line requirements. The method further includes adjusting at least one of an optical output power of the laser, a pulse repetition rate of the laser, a focal spot diameter of the laser beam, and the speed of the relative motion between the laser beam and the disc to determine a laser configuration capable of achieving the score line requirements. The score line is ablated in the rupture disc using the laser configuration to remove material from the rupture disc as vapor without melting or oxidizing disc material adjacent the material being removed.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings.

FIG. 1 is a flowchart illustrating a method of forming a score line in a rupture disc using laser machining.

FIG. 2 illustrates the thermal effects of a laser-material interaction. (See, N. B. Dahotre and S. P. Harimkar, Laser Fabrication and Machining of Materials, 2008, p. 38)

FIG. 3 illustrates the interactions of a laser beam with a material. (See, N. B. Dahotre and S. P. Harimkar, Laser Fabrication and Machining of Materials, 2008, p. 35)

FIG. 4 is a graph illustrating a plurality of laser parameter recipes.

FIG. 5(a) is a view from the concave side of an exemplary rupture disc laser machined in accordance with the teachings of the present invention.

FIG. 5(b) is a side elevational view of the rupture disc shown in FIG. 5(a).

FIG. 5(c) is a cross-sectional view of the rupture disc shown in FIGS. 5(a) and 5(b) taken along line 5C-5C in FIG. 5(a).

FIG. 6(a) is a view from the concave side of another embodiment of an exemplary rupture disc laser machined in accordance with the teachings of the present invention.

FIG. 6(b) is a cross-sectional view of the rupture disc shown in FIG. 6(a) taken along line 6B-6B in FIG. 6(a).

FIG. 7 is a view from the concave side of still another embodiment of an exemplary rupture disc laser machined in accordance with the teachings of the present invention wherein the control scores are non-linear and non-concentric.

FIG. 8(a) is a view from the convex side of another embodiment of an exemplary rupture disc laser machined in accordance with the teachings of the present invention.

FIG. 8(b) is a side elevational view of the rupture disc shown in FIG. 8(a).

FIG. 8(c) is a cross-sectional view of the rupture disc shown in FIGS. 8(a) and 8(b) taken along line 8C-8C in FIG. 8(a)

### DETAILED DESCRIPTION OF THE PREFERRED EMBODIMENTS

The following description of the preferred embodiment(s) is merely exemplary in nature and is in no way intended to limit the scope of the present invention, its applications, or uses.

The present invention involves the utilization of a laser beam to remove material from rupture discs to create lines of weakness (score lines) of various widths, depths and configurations. The following method can be utilized to score lines of weakness in any type of rupture disc including tension-type disc domes, flanges, diaphragms and panels, reverse-acting disc domes, flanges, diaphragms and panels, and any other type of rupture device. Rupture disc as used herein throughout this application is intended to include all types of forward acting tension type rupture discs, reverse-acting rupture discs, vent panels, explosion vents, explosion panels, rupture panels, and rupture diaphragms regardless of their shape and configuration including dome shaped and flat discs.

Laser machining can remove material in very small amounts and is effective for micro-machining metals, ceramics and polymers. Laser machining is a localized, noncontact, almost reactive-force free process that does not work harden the material or create residual stresses. Because of its advantages, laser machining has been effectively used in micro-machining, micro-drilling and deep engraving processes.

When score lines are machined using the appropriate laser-beam properties and settings, the characteristics of the process improve the ability of rupture discs to withstand cyclic loads and extends the service life of the disc as compared to similar rupture discs with score lines produced through mechanical scoring methods.

Machining of score lines in rupture discs with a laser beam is fast, flexible and of high quality. Furthermore, precise three-dimensional positioning and motion freedom are realized with commercial laser-machining equipment, thus allowing use of the same laser system and setup to create a variety of score line configurations and sizes. These capabilities have been translated into the machining of score lines on rupture discs. The machining flexibility of the laser equipment allows machining of score lines on both sides of rupture discs, thus making it suitable for machining score lines for both tension type and reverse-acting type rupture discs.

Laser machining involves an interaction between a laser beam and a material to achieve removal of a portion of the material as a vapor. Laser machining has been successfully applied to processes such as drilling, cutting, grooving, marking and scribing. In laser scoring of rupture discs, a layer of the disc material is ablated to form a score line. Laser machining can be used to score rupture disc materials including metals, polymers, ceramics and composites, with considerable advantages over other methods, such as the methods described above.

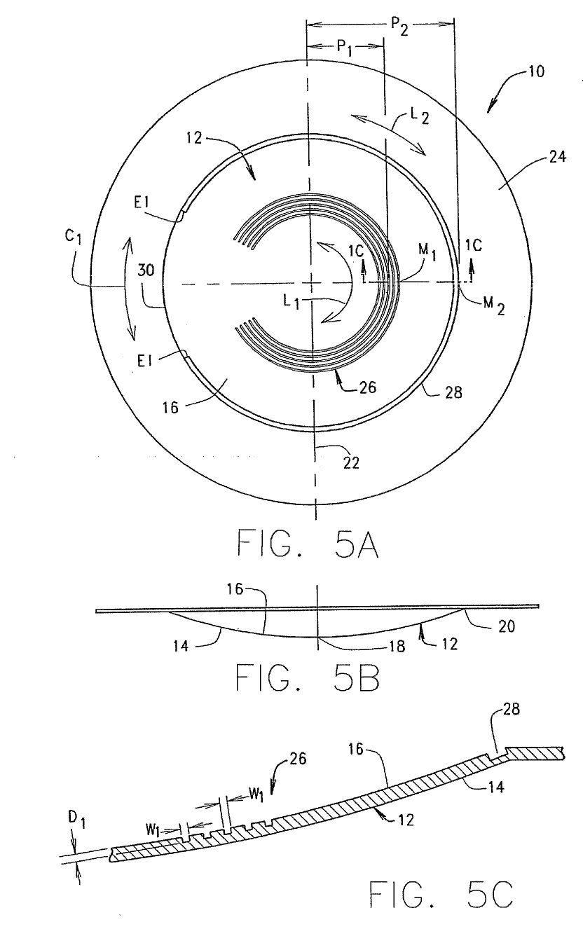

Rupture disc score lines can be formed having various configurations as described in co-pending U.S. patent application Ser. No. 12/331,611. For example, the score lines may be formed having configurations similar to those shown in FIGS. 5-8 which are discussed below.

Prior art reference U.S. Patent Application Publication No. 2006/0237457 issued to Shaw et al argues that laser scoring is unsatisfactory for a number of reasons. Particularly, Shaw states in paragraph [0011] that “the reflectivity of the metal makes it difficult to control the penetration of the beam into the thickness of the metal and thereby form a smooth groove of uniform depth along the length of the intended score line recess. Furthermore, lasers significantly heat and burn the disc, oxidize the material and change the metallurgy of the metal.” As will be discussed below, this view of laser machining is inaccurate and these alleged deficiencies can be overcome by properly controlling and adjusting certain laser properties.

Laboratory tests have shown that through careful selection of the laser beam properties and process settings, the laser beam produces score lines of various widths and depths with good quality, within manufacturing tolerances, and without pin holes or burning through the disc material, as required to produce reliable rupture discs.

In a preferred use of a laser scoring process, the material is removed through ablation. Ablation is a function of the heating rate of the disc material, which is in turn affected by the reflectivity of the material. The laser induced ablation process works by raising the temperature of the disc material above the material's boiling point at a rate fast enough to remove the disc material as vapor without melting or oxidizing the surrounding material. The temperature achieved depends on the rate of heat input and the rate at which the heat is removed from the ablation region.

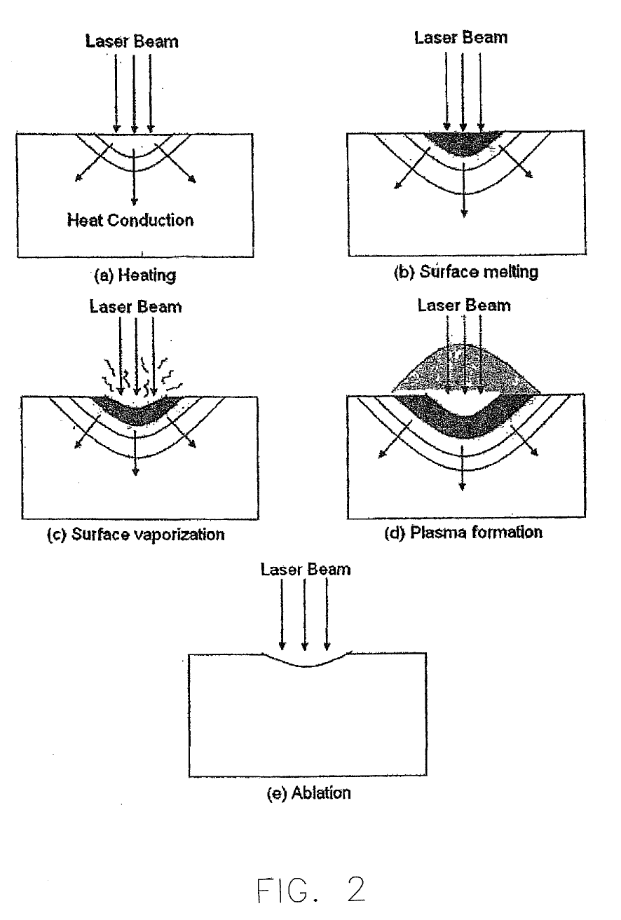

FIG. 2 illustrates various thermal effects of laser-material interaction that occur during the scoring of a rupture disc with a laser, including heating, surface melting and vaporization, plasma formation and ablation. (See, N. B. Dahotre and S. P. Harimkar, Laser Fabrication and Machining of Materials, 2008, p. 38). Depending on the laser intensities and interaction times between the laser energy and the material, one or more of these effects dominates the material removal process. The scoring of rupture discs requires micron and sub-micron machining tolerances, which in turn are better achieved through ablation. Ablation during laser processing, shown in FIG. 2(e), refers to the removal of material as a result of direct photo-thermal or photo-chemical interactions. (See, N. B. Dahotre and S. P. Harimkar, Laser Fabrication and Machining of Materials, 2008, pp. 61, 248, 249). In most metals and glasses/crystals, the typical removal of material mechanism in laser machining is through vaporization of the material due to heat as seen in FIG. 2(c). Specifically, the material experiences heat conduction, as seen in FIG. 2(a), followed by surface melting and/or vaporization as illustrated in FIGS. 2(b) and 2(c). During vaporization, it is typical for a plume of a plasma-like substance to form as shown in FIG. 2(d). The plasma generally consists of molecular fragments, neutral particles, free electrons and ions, and chemical reaction products. The plume often causes optical absorption and scattering of the incident beam, thereby causing the plume to condense on the surrounding work material and/or the beam delivery optics. Accordingly, during ablation, the removal site is typically cleared using a pressurized inert gas, such as nitrogen or argon. In other embodiments, air, oxygen and water could be used to clear the material removal site. In another embodiment, the process could be achieved with sufficient quality without the need for a gas or liquid assist to clear the removal site.

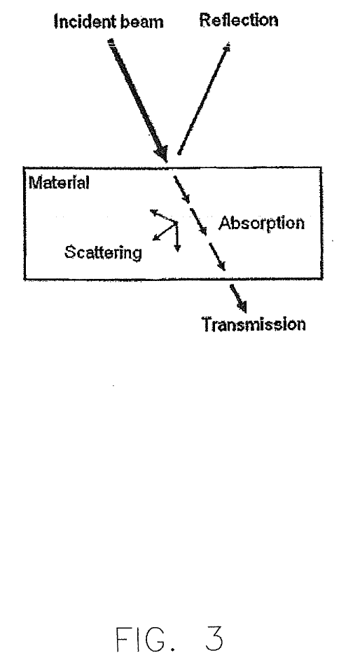

Further, the capabilities and limitations of laser machining are dependant on the physical processes occurring in the laser beam interaction with the material. As illustrated in FIG. 3, when the radiation is incident on the surface of a material, various phenomenon occur, such as reflection, refraction, absorption, scattering and transmission. The most important phenomenon in laser machining is the absorption of the radiation, which causes heating, melting, vaporization, plasma formation, and ablation, as seen in FIGS. 2(a-e). (See, N. B. Dahotre and S. P. Harimkar, Laser Fabrication and Machining of Materials, 2008, p. 34).

The rate of heat input to the material is given by the energy delivered in a laser pulse divided by the duration of the pulse and multiplied by the fraction of the pulse absorbed. Therefore the ablation needed to machine the score lines is improved with higher energy per pulse, shorter pulse duration and increased absorption. The fraction absorbed equals (1-R) for a given reflectance R. For a given material, the value of R depends on the wavelength of the laser light beam and the temperature of the material. Generally, metallic materials are stronger absorbers (less reflective) of the laser energy at lower laser wavelengths. For example, for a CO₂ laser having a far infrared laser wavelength (with a wavelength of approximately 10,000 nm) at room temperature, R is typically near 100% for many metallic materials. Therefore, the use of a CO₂ laser is not appropriate when trying to machine scores with precision. However, the reflectance R decreases with laser light of smaller wavelengths, such as yttrium aluminum garnet (YAG) lasers and excimer lasers. In addition, the local temperature increases during the laser pulse, which in turn decreases R and, therefore, increases absorption. The temperature rise depends on the rate of heat input and also the heat capacity and the rate of heat extraction, governed principally by the thermal conductivity of the material which is also temperature dependent.

Moreover, the ability of the material to absorb laser energy limits the rate and depth to which that energy can perform useful ablation. The ablation rate and depth are determined by the absorptivity of the material and the amount of heat required for vaporization of the material. The ablation rate and depth are also a function of laser beam energy density, laser pulse duration, pulse repetition rate and the laser wavelength.

As such, there are several key parameters to consider when performing laser ablation. The first is the selection of a wavelength with a minimum absorption depth to ensure a high energy deposition on the material in a small volume for rapid and complete ablation. The second parameter is a short pulse duration to maximize peak power and to minimize thermal conduction to the surrounding material. The third parameter is the pulse repetition rate. If the rate is too low, the energy not used for ablation will leave the ablation zone, thereby allowing cooling. If the residual heat can be retained to allow time for conduction using a rapid pulse repetition rate, the ablation will be more efficient. Accordingly, more of the incident energy is used for ablation and less energy is lost to the surround material and environment. The fourth parameter is the beam quality measured by the brightness, focus, and homogeneity.

Accordingly, by appropriately adjusting the laser light wavelength and the other process parameters, adequate absorption of laser light in the material with rapid local heating will be achieved, thereby resulting in control of the laser score depth and quality. In general, to overcome the reflectivity of the material and achieve a smooth groove surface with uniform depth and good surface quality with a laser machining process, the main factors to be considered for a given rupture disc material or materials are the laser wavelength, power (peak energy per pulse), pulse repetition rate, process speed, transverse or fundamental laser mode, and assist gas or liquid type.

Achieving the proper parameters requires the appropriate selection of a laser for the material to be machined. In the exemplary embodiment, the laser includes one of a YAG laser or an excimer laser. YAG lasers include an active medium consisting of a small percentage of impurity ions doped in a solid host material. YAG lasers use simple designs of flashlamps with a modest amount of pumping energy to achieve efficient population inversions. The output of a YAG laser can be continuous, pulsed, or Q-switched. Excimer lasers generate laser light in the ultraviolet to near-ultraviolet spectra. Because excimer lasers have such a short wavelength (200 nm to 350 nm), the photons have a high energy that results in reduced interaction time between laser radiation and the material. Processing with excimer lasers generally results in higher precision and reduced heat damaged zones when compared to CO₂ gas lasers and YAG lasers. Common excimer lasers include ArF, KrF, and XeCl lasers.

When selecting a laser wavelength, the wavelength should be short enough to be readily absorbed by the material or materials to be scored. In particular, different wavelengths have different effects when interacting with a material. The shorter the wavelength, the higher the energy of the photons in the laser. Moreover, the laser wavelength affects the resolution and the focalization of the laser. Specifically, a shorter wavelength results in a higher resolution and better focal properties.

In one embodiment of the present invention, YAG lasers are used to laser machine the score lines. YAG lasers are available with several different wavelengths with 1,064 nm being the largest. YAG lasers are also available in a frequency-doubled mode (532 nm), a frequency-tripled mode (355 nm), and a frequency-quadrupled mode (266 nm). Very precise score lines have been achieved in laboratory tests with YAG lasers with wavelengths between 355 and 1064 nm. These results having also been achieved with excimer lasers using a wavelength between 200 nm and 350 nm. The choice of a laser wavelength is dependent upon the desired precision and process time. For example, a shorter wavelength results in a longer process time, which results in lower manufacturing efficiency. It is important to note that during laboratory tests, attempts to utilize CO₂ lasers that have higher wavelengths on the order of 10,000 nm were not successful.

The power of a laser typically refers to the output optical power of the laser radiation. Output power is closely related to processing time and operating expense. When adjusting or programming the laser power, the laser power should be high enough to effectively ablate the material and low enough to do so without overheating the material beyond an appropriate surface layer thickness. Laboratory testing demonstrated that a laser power between 0.5 Watts and 30 Watts is adequate, when combined with appropriate process speed, pulse repetition rate and other process parameters, to achieve precise score depths in the materials and range of thickness typical of rupture discs.

The fundamental laser mode is selected to achieve an appropriate focal spot size and beam quality (M²). The mode selection is important in achieving an appropriate resolution and control of the score depth precision and quality. In particular, the cross sections of laser light beams exhibit distinct spatial profiles described by the Transverse Electromagnetic Mode (TEMₘₙ), where m and n are small integers representing the number of nodes in the two directions perpendicular to the beam axis. The fundamental model, TEM₀₀, describes a beam with a Gaussian spatial distribution of light. The focal spot size determines both the width of the score line and the irradiance of the laser. The amount of melting or ablating of a material and the consequent material removal depends on the irradiance at the material surface. A minimum focal spot diameter corresponds to a maximum irradiance.

During laboratory tests lasers were selected with a TEM₀₀ mode, an M² value or beam quality factor of 1.2, and a focal spot diameter of approximately 20 μm to 100 μm. This mode achieved the appropriate laser beam spot size and quality and extended the beam path length of the laser to a near constant beam size. Accordingly, the effect of disc curvature on the beam focus was minimized over relatively small changes in the material surface. In other embodiments, various modes and focal spot sizes may be used to control the depth and width of the score line while ablating the disc material.

In one embodiment, an assist gas jet is used to facilitate the material removal at the ablation site and increase the efficiency of the laser by removing absorptive vapors and debris that can affect the incident laser energy from reaching the target material. Various assist gases such as air, oxygen, argon and nitrogen are typically used. The optimal choice of a gas type depends on the material to be machined and the application of the disc. For typical rupture disc materials such as stainless steel, nickel, Hastelloy C, Inconel and Monel, the most utilized gas assist options are air, oxygen, nitrogen and argon.

The factors described above have to be evaluated against economic considerations in selecting the optimal laser system for scoring rupture discs. With regard to the statement in paragraph [0011] of the Shaw publication that “lasers significantly heat and burn the disc, oxidize the material and change the metallurgy of the metal,” a careful selection of laser machining process parameters, score depth, score width-to-depth ratio and the use of an assist gas effectively control the thickness of the heat affected material layer to be within a few microns, and therefore this will not affect in any significant way the performance of the rupture disc device. If desired, the oxidation of the material surface can be eliminated with the use of an inert assist gas such as argon.

Laboratory tests have further shown that, when using laser scoring with an adequate selection of laser and process parameters, the heat-affected zone is narrow and the re-solidified layer is of micron dimensions. Distortion is therefore negligible. Various tests have shown that the heat-affected zone is of such small dimensions that it does not affect negatively the overall mechanical characteristics or performance of the device for the range of commercial applications typical of a rupture disc device.

Moreover, by properly setting the parameters of the laser, the reflectivity of the material can be considered and compensated so that score lines are machined with good control and quality. In addition, the thermal effects of the laser ablation are also controlled to avoid any negative effect on the rupture disc performance.

Accordingly, the advantages of laser scoring rupture discs over mechanical scoring can be summarized as follows.

Laser scoring provides a localized, non-contact machining, and is almost reacting-force free. For example, the forces involved in laser scoring result from photon induced pressure on the target material and these forces are on a micro scale and are therefore negligible as compared to mechanical scoring. This offers the laser scoring a process control and repeatability that is difficult and expensive to maintain with mechanical scoring processes, which utilize mechanical presses (typically hydraulic or pneumatic). Therefore, laser scoring provides more repeatability and control of the score depth at a significantly lesser cost that mechanical scoring.

Because the forces involved in laser scoring are very small, this process does not induce residual stresses in the score area. Conversely, mechanical scoring creates areas of work hardening in the score area. Accordingly, laser scoring improves the properties of the rupture disc to withstand cyclic fatigue and minimizes the possibility of an early activation (opening) of the rupture disc.

Additionally, laser scoring can remove material in very small amounts. The depth of laser scoring per laser pulse can be controlled in an order of magnitude of microns, which makes it ideal for micro-machining. Laser scoring of a sheet material with thickness less than 2 mm can be fast and of high quality.

The number, depth, width, length, radial position and configuration of score lines are also readily programmable without the need of multiple mechanical tools and setups. Precise three-dimensional control of the laser scoring process can be conveniently realized, thus resulting in a scoring process with great dimensional freedom. Therefore, the design of the scores can be modified and optimized for specific customer applications without incurring the high costs of multiple score tooling and time consuming change of setups.

Moreover, the heat affected zone in laser scoring is very narrow. Particularly, through careful consideration of the score width-to-depth ratio and score depth, and using short wavelengths and an appropriate gas-assisted cooling system, the thickness of the heat affected layers is in the magnitude of a few microns with negligible thermal and mechanical distortions and, therefore, it does not adversely affect the function of the rupture disc.

Further, laser scoring can be applied to any material that can properly absorb the laser radiation, including metals, plastics and hard or brittle materials such as ceramics. Because the absorption properties of different materials vary, an appropriate selection of laser and laser scoring process parameters is necessary depending on the rupture disc material.

As such, laser machining has been shown to be appropriate in machining of score lines of various widths, depths and configurations to facilitate the reliable opening of rupture discs, including tension type discs and reverse-acting type discs. Typical configurations include, but are not limited to, cross scores and circumferential scores. Laser machining is also appropriate for machining of score lines of various depths and configurations at strategic locations on the disc dome to selectively control the reversal pressure of reverse-acting type discs.

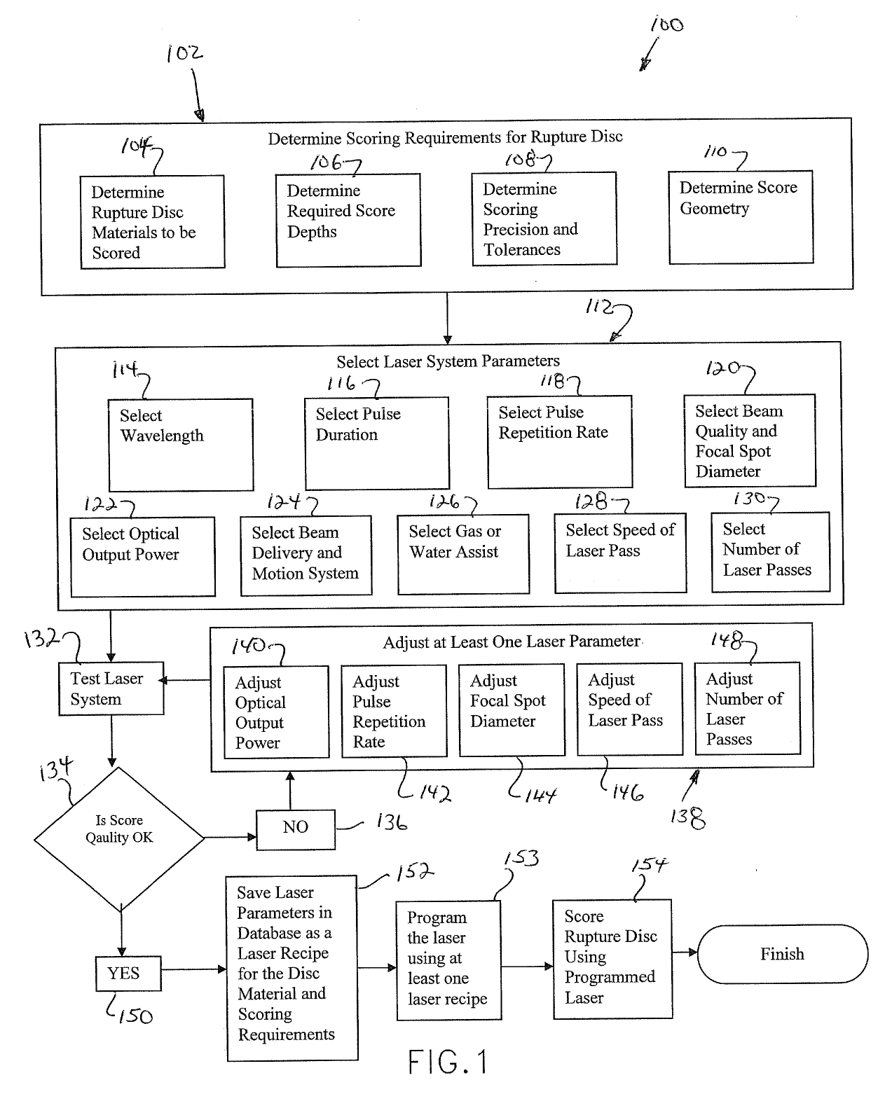

Accordingly, the present invention provides a method 100, as illustrated in FIG. 1, for forming score lines in a rupture disc. The method includes a first step 102 of determining the scoring requirements for the rupture disc. The determination of scoring requirements includes at least one of determining at step 104 the disc materials, determining at step 106 the required score depths, determining at step 108 the required scoring precision and tolerances, and determining at step 110 the geometry of the score lines. The score depths and geometry are discussed in more detail below with respect to FIGS. 5-8. With respect to the disc materials, in the exemplary embodiment, the disc materials may be selected from polymers, composites, ceramics, and metals such as stainless steel, nickel, Hastelloy C, Inconel and Monel.

Next, the laser system parameters are selected at step 112. Selecting the laser system parameters may include selecting any one of or any combination of the parameters discussed herein. The parameters selected may depend upon the existing laser system already in use, or it may include selecting a new laser system based upon the below discussed parameters and optimal ranges for scoring rupture discs. The laser parameters selected may include selecting at step 114 the wavelength of the laser, selecting at step 116 the pulse duration of the laser, selecting at step 118 the pulse repetition rate of the laser, and selecting at step 120 the beam quality and focal spot diameter of the laser. The wavelength of the laser is dependent on the type of laser selected for the laser machining process and is selected to maximize the absorption of the laser radiation by the disc material. In the exemplary embodiment, an excimer laser or a solid-state laser, preferably a YAG laser is used for the process. Excimer lasers generally are available with a wavelength of between approximately 200 nm to approximately 350 nm. Solid-state lasers typically have a wavelength of 1,064 nm, 532 nm, 355 nm, or 266 nm. Accordingly, a wavelength of between approximately 200 nm to approximately 1,064 nm is ideal for the laser machining process. The pulse duration is selected to maximize a peak power of the laser, and the pulse repetition rate is selected to reduce a heat affected zone of the rupture disc during ablation. In the exemplary embodiment, a pulse repetition rate of between approximately 2 kHz to approximately 10 kHz was selected. The focal spot diameter was selected within a range of between approximately 20 μm to approximately 100 μm to obtain an optimal irradiance for achieving the required score line precision and tolerances. In addition, a beam quality factor of approximately 1.2 was ideal in the exemplary embodiment.

Other laser parameters selected at step 112 include selecting at step 122 the optical output power, selecting at step 124 the beam delivery and motion system, selecting at step 126 a gas or water assist, selecting at step 128 the speed of relative motion between the laser and the disc at each pass of the laser, and selecting at step 130 a number of laser passes. The use of gas or water assist is described in more detail above. In laboratory tests, a laser system having a three-dimensional beam delivery and motion system with an optical output power of between approximately 0.5 Watts to approximately 30 Watts was ideal for the laser machining process. Further, laser speeds within a range of between approximately 10 mm/s and approximately 60 mm/s were successful in laboratory tests.

It should be noted that the parameters selected in steps 112-130 are not exclusive and the ranges described herein are exemplary only and do not necessarily represent the only available ranges for successfully performing laser machining on a rupture disc. Moreover, as will be appreciated by one of ordinary skill in the art, not all of the above referenced parameters may be necessary for the laser machining process, but rather, the parameters selected will depend on the scoring requirements for the rupture disc.

After selecting at steps 102-110 the scoring requirements of the rupture disc and selecting at steps 112-130 the laser system parameters necessary to achieve the scoring requirements, the laser system is tested at step 132 on a rupture disc to ablate a score line by removing material from the rupture disc as vapor without melting or oxidizing disc material adjacent the material being removed. After ablating of the score line, the quality of the score line is verified at step 134. If the scoring does not meet the quality standards necessary for the rupture disc at step 136, at least one of the parameters of the laser identified in step 138 is adjusted at step 138. In laboratory tests, the best results were achieved by adjusting one of the following parameters: adjusting at step 140 the optical output power, adjusting at step 142 the pulse repetition rate, adjusting at step 144 the focal spot diameter, adjusting at step 146 the speed of relative motion between the laser and the disc at each pass of the laser, and adjusting at step 148 the number of passes. In the exemplary embodiment, the optical output power was adjusted at step 140 within a range of between approximately 1 Watts to approximately 30 Watts, the pulse repetition rate was adjusted at step 142 within a range of between approximately 2 kHz to approximately 10 kHz, the focal spot diameter was adjusted at step 144 within a range of between approximately 20 μm to approximately 100 μm, and the speed of the laser pass was adjusted at step 146 within a range of between approximately 10 mm/s and approximately 60 mm/s. After adjusting the laser parameters at step 138, the laser is again tested at step 132 on a rupture disc and the quality of the score line is again checked at step 134. If the quality of the score lines meets the scoring requirements of step 102 and is satisfactory at step 150, these particular laser parameters are saved at step 152 in a database as a laser recipe. This recipe, or any other recipe or combination of recipes, can then be programmed into the laser system at step 153 for use in future laser machining processes at step 154 to achieve the scoring requirements selected in steps 102-110. Accordingly, a database can be created which will cut production time for scoring future rupture discs by selecting an appropriate recipe(s) from the database based upon the score line requirements of additional rupture discs.

It should be noted that the parameters adjusted in step 138 are not exclusive and the ranges described herein are exemplary only and do not necessarily represent the only available ranges for successfully performing laser machining on a rupture disc. Moreover, as will be appreciated by one of ordinary skill in the art, not all of the above referenced parameters need be adjusted at step 138 for the laser machining process, but rather, specific parameters are adjusted at step 138 depending upon the quality check at step 134 based upon the laser test at step 132 and any deficiencies noted with respect to the score line requirements established at steps 102-110.

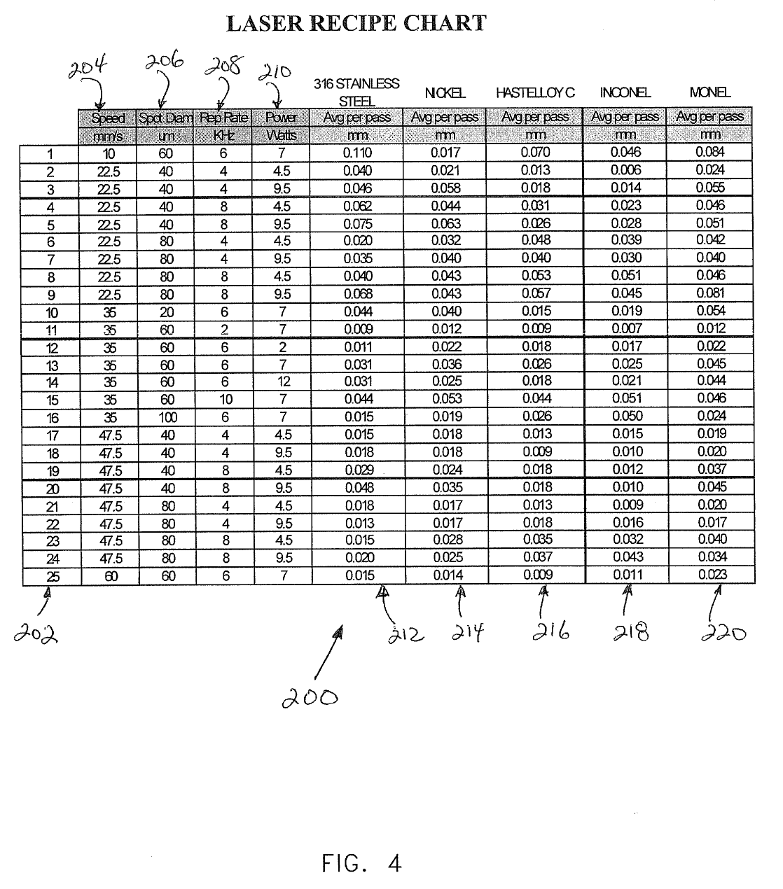

Chart 200 shown in FIG. 4 illustrates the depth of score lines achieved using various recipes on a diode-pumped ND:Yag laser with a wavelength of 1064 nm and a TEM₀₀ light beam within the ranges set forth above on a single pass of the laser. Column 202 represents twenty-five (25) different laser recipes using the above-described ranges. For each recipe, column 204 represents the speed of the laser, column 206 represents the focal spot diameter of the laser, column 208 represents the pulse repetition rate of the laser, and column 210 represents the power of the laser. Column 212 represents the average depth per pass of the score line achieved on a 316 stainless steel rupture disc using each recipe, column 214 represents the average depth per pass of the score line achieved on a nickel rupture disc using each recipe, column 216 represents the average depth per pass of the score line achieved on a hastelloy C rupture disc using each recipe, column 218 represents the average depth per pass of the score line achieved on an inconel rupture disc using each recipe, and column 220 represents the average depth per pass of the score line achieved on a monel rupture disc using each recipe.

For example, recipe 1 utilized a 7 Watt laser having a pulse repetition rate of 6 kHz, a focal spot diameter of 60 μm, and a laser speed of 10 mm/s. Using recipe 1, an average score depth per pass of 0.110 mm was laser machined in a stainless steel rupture disc, an average score depth per pass of 0.017 mm was laser machined in a nickel rupture disc, an average score depth per pass of 0.070 mm was laser machined in a hastelloy C rupture disc, an average score depth per pass of 0.046 mm was laser machined in an inconel rupture disc, and an average score depth per pass of 0.084 mm was laser machined in a monel rupture disc. In contrast, recipe 2 utilized a 4.5 Watt laser having a pulse repetition rate of 4 kHz, a focal spot diameter of 40 μm, and a laser speed of 22.5 mm/s. Using recipe 2, an average score depth per pass of 0.040 mm was laser machined in a stainless steel rupture disc, an average score depth per pass of 0.021 mm was laser machined in a nickel rupture disc, an average score depth per pass of 0.013 mm was laser machined in a hastelloy C rupture disc, an average score depth per pass of 0.006 mm was laser machined in an inconel rupture disc, and an average score depth per pass of 0.024 mm was laser machined in a monel rupture disc.

Different score depths can also be achieved by varying the number of passes used in the laser machining process. For example, by utilizing two passes of recipe 1, a score depth of 0.220 mm can be laser machined in a stainless steel disc, a score depth of 0.034 mm can be laser machined in a nickel rupture disc, a score depth of 0.140 mm can be laser machined in a hastelloy C rupture disc, a score depth of 0.092 mm can be laser machined in an inconel rupture disc, and a score depth of 0.168 mm can be laser machined in a monel rupture disc. Additionally, recipes can be combined to achieve a desired score depth. For example, by utilizing one pass of recipe 1 and one pass of recipe 2, a score depth of 0.150 mm can be laser machined in a stainless steel disc, a score depth of 0.038 can be laser machined in a nickel rupture disc, a score depth of 0.083 mm can be laser machined in a hastelloy C rupture disc, a score depth of 0.052 mm can be laser machined in an inconel rupture disc, and a score depth of 0.108 mm can be laser machined in a monel rupture disc. Accordingly, depending on the depth of score required, the appropriate recipe or combination of recipes can be selected from the database of recipes to achieve repeatability and uniformity when laser machining multiple rupture discs. These recipes, and any combination thereof, can be programmed into the laser system for scoring future rupture discs.

With respect to determining at step 106 the required score depth and determining at step 110 the required score geometry, the laser can be programmed prior to machining to provide score lines in various different formations. Specifically, the laser can be programmed to machine various numbers of score lines having various depths, widths, lengths, and radial positions. It can be used to machine score lines in all types of rupture discs including forward-acting tension type rupture discs, reverse-acting rupture discs, vent panels, explosion panels, explosion vents, rupture panels and rupture diaphragms.

For example, FIG. 5 illustrates one embodiment of an exemplary rupture disc 10 machined in accordance with the teachings of the present invention. The disc 10 includes a concentric dome 12 having a circumference C1, a convex side 14 and a concave side 16. The dome 12 also includes an apex 18 and an outer circumference 20. A radial position on the dome 12 is measured from an axis 22 extending through the apex 18 of the dome 12 to the outer circumference 20 of the dome 12. An annular flange 24 extends outwardly from the outer circumference 20 of the dome 12 and circumferentially around the dome 12. The disc 10 is manufactured to a geometry and thickness that are suitable for the pressure range of the system in which the disc 10 will be applied. In the exemplary embodiment, the method of the present invention is capable of laser machining a disc having any geometry or thickness.

The present method of laser machining is used to form at least one control score 26 and a rupture score 28. The control score 26 weakens the dome 12 to control a pressure at which the dome 12 will begin to collapse, whereas the rupture score 28 provides a preferred location at which the disc 10 ruptures. As discussed above, the depth D1, length L1, width W1, and radial position P1 of the control score(s) 26 are programmed into the laser prior to machining to provide a rated reversal load for the disc 10 so as to achieve a predetermined rupture pressure. In one embodiment, the at least one control score 26 is formed or otherwise produced in the concave side 16 of the dome 12. Forming the at least one control score 26 on the concave side 16 of the dome 12 preserves a smooth face on the convex side 14 of the dome 12. Accordingly, the disc 10 is without grooves and/or indentations or other markings on the dome's convex side 14 so that the disc 10 can be used in applications where sanitary conditions within the system are of concern.

The at least one control score 26 is radially positioned on the dome 12 between an apex 18 of the dome 12 and an outer circumference 20 of the dome 12 at a radial position P1 (see FIG. 5(a)). The at least one control score 26 does not cut entirely through the thickness of the dome 12, but rather only cuts through a portion of the thickness of the dome 12 as best illustrated in FIG. 5(c). In the exemplary embodiment shown in FIG. 5, a plurality of control scores 26 are laser machined in the concave side 16 of the dome 12. Each of the plurality of control scores 26 is positioned at a different radial position P1 between the apex 18 of the dome 12 and the outer circumference 20 of the dome 12.

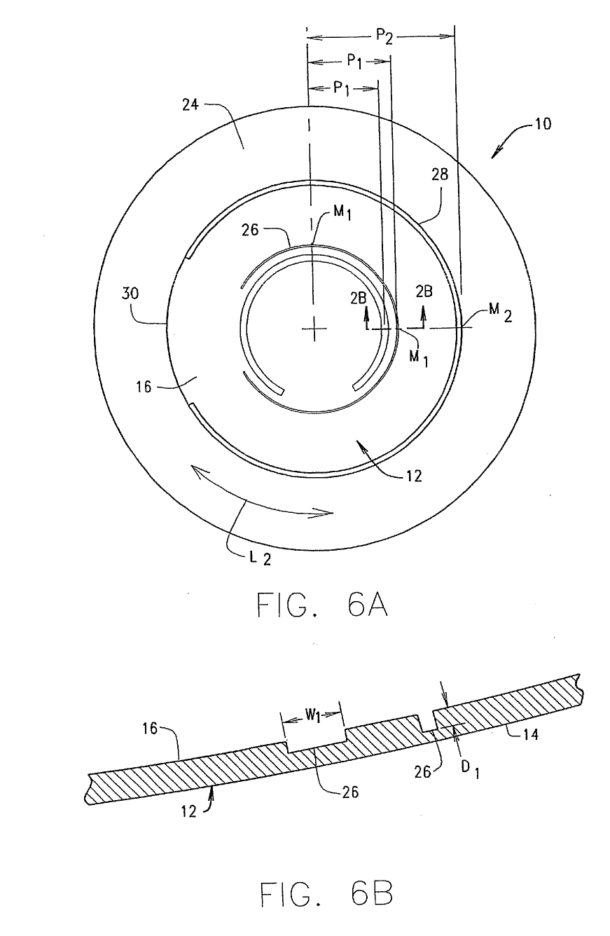

In an alternative embodiment, as shown in FIG. 6, at least one of the plurality of control scores 26 has a different length L1 and/or is staggered so that the midpoint M1 of at least one control score 26 is not aligned with the midpoint M1 of other control scores 26. Also, as shown in FIG. 6(b), at least one of the plurality of control scores 26 has a different depth D1 and/or a different width W1 than the other control scores 26.

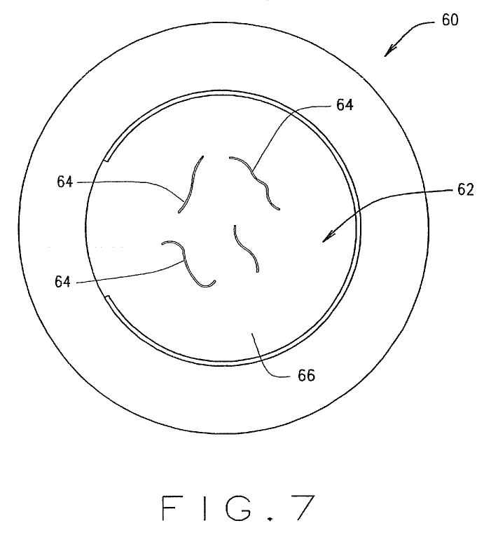

Accordingly, laser machining provides any variation of control scores and rupture scores including using a shape different from the annular or arc shaped control scores 26 illustrated in FIGS. 5 and 6. Specifically, the present invention may be used to laser machine control scores that are straight (linear), non-linear and/or non-concentric positioned at various locations about the dome. For example, the control scores may have a radial position that changes along the length of the control scores. In another example, the control scores may criss-cross and/or be a series of non-linear line segments. See, for example, FIG. 7 wherein the disc 60 includes a dome 62 having non-linear and non-concentric control scores 64 associated with the concave side 66 of dome 62, the control scores 64 likewise having selectively determinable lengths, widths and depths. The location and number of control scores 64 are also programmed to achieve the appropriate reversal pressure for a particular application. Other variations are likewise anticipated and recognized. All of these score requirements and parameters can be programmed into the laser system for scoring rupture discs.

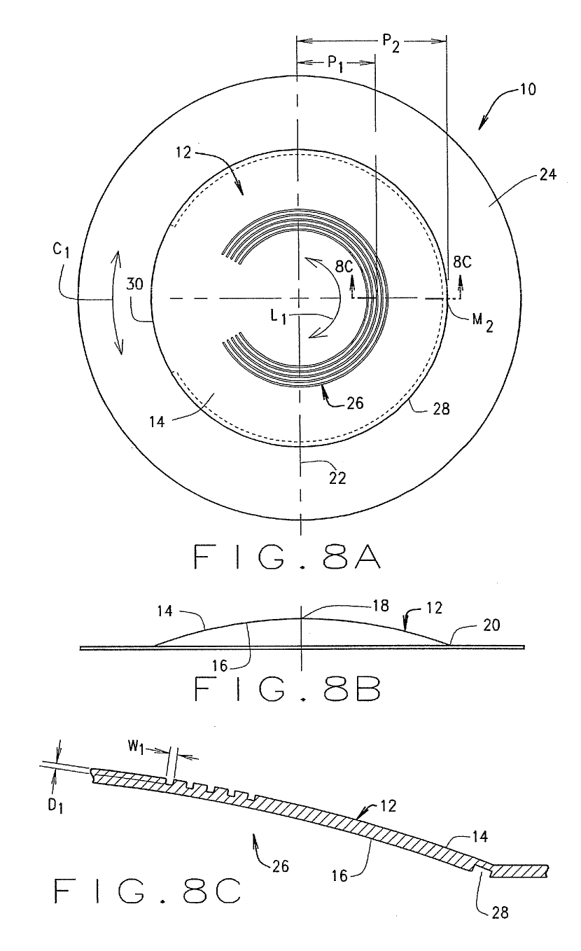

In certain applications, it is also recognized that the control scores 26 and 64, as illustrated in FIGS. 5-7, can likewise be formed on the convex side of the dome of a particular rupture disc. In applications where sanitary conditions are not a factor, control scores formed on the convex side of a particular rupture disc can likewise be utilized to control the reversal pressure of a particular disc. For example, as illustrated in FIGS. 8(a), 8(b) and 8(c), at least one of a plurality of control scores 26 can be laser machined on the convex side 14 of the disc dome 12. Like the control scores illustrated in FIG. 5, each of the control scores 26 in FIG. 8 is positioned at a different radial position P1 between the apex 18 and the outer circumference 20 of the dome 12.

As with the control scores illustrated in FIGS. 5 and 6, each of the control scores 26 of FIG. 8 have an arcuate length and a midpoint as illustrated. As best illustrated in FIG. 8(c), the control scores 26 are formed or otherwise produced on the convex side 14 of the dome 12 whereas the rupture score 28 is formed on the concave side 16 of the dome 12. As discussed above, the depth D1, the length L1, the width W1, and the radial position P1 of the control scores 26 are programmed into the laser system prior to machining to achieve a predetermined rupture pressure for the disc 10. In addition, similar to the control scores illustrated in FIG. 6, at least one of the plurality of control scores 26 associated with the embodiment illustrated in FIG. 8 can have a different length L1 and/or can be staggered so that the midpoint of at least one control score is not aligned with the midpoint of other control scores. Also, at least one of the plurality of control scores in the embodiment illustrated in FIG. 8 can have a different depth D1 and/or a different width W1 than other control scores as previously discussed and illustrated in FIG. 6.

As a result, all of the disclosures set forth above with respect to the various control scores and the ability to selectively program the length, width, depth, number and radial location of such control scores are equally applicable whether such control scores are formed on the concave or convex side of the dome of the disc. By programming these configurations into the laser system and by selecting and programming the laser parameters for a particular scoring application prior to machining, the laser is capable of providing precise, repeatable, and efficient score lines when machining multiple discs, characteristics not achieved when using mechanical machining.

It is also recognized that the term “rupture disc” as defined herein includes all types and configurations of forward acting tension type discs as well as reverse-acting rupture discs including all types of rupture diaphragms, vent panels, explosion vents, rupture panels and/or explosion panels as those terms are understood in the industry. As a result, the term “rupture disc” includes all shapes and configurations of rupture type diaphragms including dome-shaped discs as well as flat or substantially flat discs so long as such rupture discs are used in a pressurized fluid system. As a result, all of the claims set forth below are intended to cover a method of forming a laser score on any such rupture disc regardless of the shape and/or configuration of such rupture disc as defined above.

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A method of forming a score line in a rupture disc using a laser, the method comprising:
determining score line requirements for the rupture disc;
selecting a laser to achieve the score line requirements for the rupture disc; and
ablating the score line in the rupture disc using the laser to remove material from the rupture disc.

2. The method in accordance with claim 1 wherein selecting a laser further includes:
selecting a wavelength for the laser that maximizes absorption of the laser by the disc material;
selecting a pulse duration for the laser that maximizes a peak power of the laser; and
selecting a pulse repetition rate for the laser that reduces a heat affected zone of the rupture disc during ablation.

3. The method in accordance with claim 2 further including selecting a wavelength within a range of between approximately 200 nanometers and approximately 1064 nanometers.

4. The method in accordance with claim 2 further including selecting a pulse repetition rate within a range of between approximately 2 kHz and approximately 10 kHz.

5. The method in accordance with claim 1 further including selecting at least one of a speed of relative motion between the laser and the rupture disc for each pass of the laser and a number of laser passes.

6. The method in accordance with claim 5 further including selecting a speed of relative motion between the laser and the rupture disc for each pass of the laser within a range of between approximately 10 mm/s and approximately 60 mm/s.

7. The method in accordance with claim 1 wherein selecting a laser further includes selecting a laser having a power within a range of between approximately 0.5 Watts and approximately 30 Watts.

8. The method in accordance with claim 1 wherein selecting a laser further includes selecting a focal spot diameter of the laser within a range of between approximately 20 μm and approximately 100 μm.

9. The method in accordance with claim 1 wherein selecting a laser further includes selecting a beam quality factor of approximately 1.2 for the laser.

10. The method in accordance with claim 1 wherein determining the score line requirements for the rupture disc includes determining at least one of a disc material, a score line depth, and a score line geometry.

11. The method in accordance with claim 1 wherein ablating the score line in the rupture disc further includes raising the temperature of a disc material being removed above a boiling point of the disc material.

12. The method in accordance with claim 1 further including removing absorptive vapors and debris from the rupture disc during the ablating process using at least one of a gas jet and a water jet.

13. The method in accordance with claim 1 wherein selecting a laser further includes selecting a laser having a three-dimensional beam delivery and motion system.

14. A method of forming a score line in a rupture disc using a laser, the method comprising:
determining score line requirements for the rupture disc;
adjusting parameters of the laser to achieve the score line requirements for the rupture disc; and
ablating the score line in the rupture disc using the laser to remove material from the rupture disc.

15. The method in accordance with claim 14 wherein adjusting parameters of the laser further includes adjusting at least one of:
a power of the laser,
a pulse repetition rate of the laser to enable residual heat to be retained in a scoring zone of the rupture disc, and
a focal spot diameter of the laser to enable achieving the score line requirements for the rupture disc.

16. The method in accordance with claim 15 wherein the power of the laser is adjusted within a range of between approximately 0.5 Watts and approximately 30 Watts.

17. The method in accordance with claim 15 wherein the focal spot diameter of the laser is adjusted within a range of between approximately 20 μm and approximately 100 μm.

18. The method in accordance with claim 15 wherein the pulse repetition rate of the laser is adjusted within a range of between approximately 2 kHz and approximately 10 kHz.

19. The method in accordance with claim 14 further including removing absorptive vapors and debris from the rupture disc using at least one of a gas jet and a water jet.

20. The method in accordance with claim 14 wherein adjusting parameters of the laser further includes adjusting at least one of a speed of each pass of the laser and a number of laser passes.

21. The method in accordance with claim 20 wherein the speed of each pass of the laser is adjusted within a range of between approximately 10 mm/s and approximately 60 mm/s.

22. The method in accordance with claim 14 wherein determining score line requirements for the rupture disc further includes selecting at least one of a disc material, a score line depth, a score line geometry, and a score line precision and tolerance.

23. The method in accordance with claim 14 including storing the parameters of the laser as a laser recipe for achieving the score line requirements in a database for future use.

24. The method in accordance with claim 23 including programming the laser with at least one laser receipt to achieve the score line requirements.

25. A method of forming a score line in a rupture disc using a laser, the method comprising:
determining score line requirements for the rupture disc;
selecting a laser for achieving the score line requirements;
adjusting parameters of the laser to achieve the score line requirements; and
ablating the score line in the rupture disc using the laser to remove material from the rupture disc.

26. The method in accordance with claim 25 further including storing the parameters of the laser as a laser recipe for achieving the score line requirements.

27. The method in accordance with claim 26 further including programming the laser with the laser recipe to achieve the score line requirements when ablating the rupture disc.

28. The method in accordance with claim 25 further including testing the laser by ablating a rupture disc prior to adjusting parameters of the laser.

29. The method in accordance with claim 28 wherein adjusting parameters of the laser includes adjusting such parameters based upon the results of the testing step.

30. The method in accordance with claim 25 wherein determining score line requirements for the rupture disc further includes selecting at least one of a disc material, a score line depth, a score line geometry, and a score line precision and tolerance.

31. The method in accordance with claim 25 wherein selecting a laser further includes:
selecting a wavelength for the laser within a range of between approximately 200 nanometers and approximately 1064 nanometers; and
selecting a pulse repetition rate for the laser within a range of between approximately 2 kHz and approximately 10 kHz.

32. The method in accordance with claim 25 wherein adjusting parameters of the laser further includes adjusting at least one of:
a power of the laser within a range of between approximately 0.5 Watts and approximately 30 Watts;
a pulse repetition rate of the laser within a range of between approximately 2 kHz and approximately 10 kHz; and
a focal spot diameter of the laser within a range of between approximately 20 μm and approximately 100 μm.

33. The method in accordance with claim 25 wherein adjusting parameters of the laser further includes adjusting at least one of a speed of each pass of the laser within a range of between approximately 10 mm/s to approximately 60 mm/s and a number of laser passes.

34. The method in accordance with claim 25 wherein selecting a laser further includes selecting a beam quality factor of approximately 1.2 for the laser.

35. A method of forming a score line in a rupture disc using a laser, the method comprising:
determining the rupture disc material to be scored;
determining the score line depth;
determining the score line geometry;
determining the score line tolerances;
selecting a wavelength for the laser that maximizes absorption of the laser radiation by the disc material;
selecting a pulse duration for the laser that maximizes a peak power of the laser;
selecting a pulse repetition rate for the laser that reduces a heat affected zone of the rupture disc during scoring;
selecting the focal spot diameter of the laser;
selecting the optical output power of the laser;
selecting the speed of relative motion between the laser and the rupture disc for each laser pass;
selecting the number of laser passes; and
ablating the score line in the rupture disc to remove material from the rupture disc.

36. The method in accordance with claim 35 further including using at least one of a gas jet and a water jet to remove vapors and debris from the rupture disc during the ablating process.
